(19) United States
(12) Patent Application Publication
(10) Pub. No.: US 2021/0394137 A1
(43) Pub. Date: Dec. 23, 2021

(54) STIRRER ASSEMBLY

(71) Applicants: Michael Josias CRONJE, Centurion (ZA); Astrid Renee Catherine CRONJE, Centurion (ZA)

(72) Inventors: Michael Josias CRONJE, Centurion (ZA); Astrid Renee Catherine CRONJE, Centurion (ZA)

(21) Appl. No.: 17/250,761

(22) PCT Filed: Sep. 30, 2019
(86) PCT No.: PCT/ZA2019/050062

§ 371 Date: Mar. 2, 2021

(30) Foreign Application Priority Data
Oct. 2, 2018 (ZA) 2018/06522
Mar. 8, 2019 (ZA) 2019/01438

(51) Int. Cl. B01F 7/16; B01F 7/00; B01F 7/18; B01F 15/00

(52) U.S. Cl. CPC B01F 7/1695; B01F 7/003; B01F 2215/005; B01F 7/18; B01F 15/00506; B01F 7/165

(57) ABSTRACT

A stirrer assembly for, in use, stirring liquid in a receptacle with the receptacle lid in place, which includes a receptacle receiving portion which is locatable inside the receptacle, a first guide member which is mountable onto a floor of the receptacle for rotatably guiding the receptacle receiving portion, a second guide member which is defined centrally a receptacle lid and extending downward therefrom, for in use, rotatably guiding an upper region of receptacle receiving portion, a sealing member for releasably sealing the second guide member, and a drive member which is connectable to the upper region of the receptacle receiving portion, for in use, transmitting torque to the shaft upon rotation of the said drive member.

### TECHNICAL FIELD

The invention relates to a stirrer assembly, more particularly a stirrer assembly, a portion of which is mountable in a liquid receptacle for stirring liquid contained in the receptacle while keeping the receptacle lid in place.

### BACKGROUND

Paint is usually sold in cylindrical shaped containers, and prior to use the paint need to be stirred thoroughly, for the purpose of either mixing the paint solutions together, or in the case of pigmented paints, in order to re-distribute the pigments which have fallen out of colloidal suspension in order for the proper result to be achieved.

Currently the user will use a stock or any elongate rod type element to stir the paint before use, or, rely on the paint store to stir the paint by use of a specially designed shaker. When the user buys several paint containers the risk is that the paint may have separated and or fallen out of suspension by the time the last container is used.

The applicants having considered the above proposes the below invention.

For the purpose of this specification the term mixing shall mean to include the term stirring.

For the purpose of this specification the term liquid shall mean to include the term fluid.: KER

### SUMMARY OF THE INVENTION

According to the invention there is provided a stirrer assembly for, in use, stirring liquid in a receptacle, which includes:

a receptacle receiving portion which is locatable inside the receptacle;

the receptacle receiving portion further including:
a shaft; and
a paddle member extending from a bottom region of the shaft;

a first guide member which is mountable onto a floor of the receptacle for rotatably guiding the paddle member;

a second guide member which is defined centrally a receptacle lid and extending downward therefrom, for in use, rotatably guiding an upper region of the shaft;

a sealing member for releasably sealing the second guide member; and

a drive member which is connectable to the upper region of the shaft, for in use, transmitting torque to the shaft upon rotation of the said drive member;

wherein the receptacle receiving portion is dimensioned so that the upper end region of the shaft does not protrude beyond an upper surface of the second guide member.

The shaft may include a drive member interconnecting formation defined about an upper end region thereof for releasable interconnecting with the drive member.

The shaft may include a paddle member interconnecting formation defined about a lower end region thereof for releasable interconnecting with the paddle member.

The shaft may include the paddle member.

The paddle member may include a guide receiving formation for rotatably receiving the first guide member.

The paddle member may include a blade arranged transversally the shaft.

The paddle member may include three or more evenly spaced apart blades radiating from the guide receiving formation.

The guide receiving formation may further be frustoconically shaped, with a tapered end region thereof adapted to accommodate the first guide member.

Each of the three blades may further include apertures defined therethrough so as to define a perforated paddle member.

The first guide member may include a guide protrusion protruding from the receptacle floor. The first guide member may be arranged centrally the receptacle floor.

The second guide member may be shaped and sized to fit in a friction fit manner in a centrally defined aperture of the lid.

The second guide member may include sealing formations for sealably mounting the second guide member into the centrally defined aperture of the lid.

The sealing formations may take the form of a pair of washers mounted on either side of the lid.

The sealing formations may be in the form of a flanges extending circumferentially about an upper end region of the second guide member.

The lid may include the second guide member.

The second guide member may include a centrally defined guide bore for receiving an upper end region of the shaft.

The inner surfaces of the guide bore may be threaded for receiving a complementary threaded surface defined about the sealing member so as to allow screwing of the sealing member into the second guide member.

The guide bore may have an inner diameter of about 10 mm

The drive member may be substantially L shaped in side view and including a shaft connecting portion extending orthogonally away therefrom for releasable interconnection with an upper region of the shaft.

### BRIEF DESCRIPTION OF THE DRAWINGS

The invention will now be described by way of the following, non-limiting example with reference to the accompanying drawings.

In the drawings: —

FIGS. 1 and 2 are schematic illustrations of the stirrer assembly;

FIG. 3 shows one form of the paddle member;

FIG. 4 is a schematic illustration of the shaft;

FIG. 5 is a schematic illustration of the drive member;

FIG. 6 is a schematic illustration of the drive member when not in use;

FIG. 7 is a schematic illustration of another form of the paddle member;

FIG. 8 is a schematic illustration of the second guide member including the sealing member;

FIG. 9 is a schematic of the sealing member depicted in FIG. 8; and

FIG. 10 is a schematic of the second guide member depicted in FIG. 8, in accordance with the invention.

### DETAILED DESCRIPTION OF THE DRAWINGS

In the drawings, reference numeral 10 generally depicts a stirrer assembly in accordance with the invention.

According to the invention there is provided a stirrer assembly 10 for, in use, stirring liquid in a receptacle 12, which includes a receptacle receiving portion 14 which is locatable inside the receptacle 12, the receptacle receiving portion 14 further including a shaft 16 and a paddle member 18 extending from a bottom region of the shaft 16, a first guide member 20 which is mountable onto a floor 22 of the receptacle 12 for rotatably guiding the paddle member 18, a second guide member 24 which is defined centrally a receptacle lid 26 and extending downward therefrom, for in use, rotatably guiding an upper region of the shaft 16, a sealing member 28 for releasably sealing the second guide member 24, and a drive member 30 which is connectable to the upper region of the shaft 16, for in use, transmitting torque to the shaft 16 upon rotation of the said drive member 30, wherein the receptacle receiving portion 14 is dimensioned so that the upper end region of the shaft 16 does not protrude beyond an upper surface of the second guide member 24.

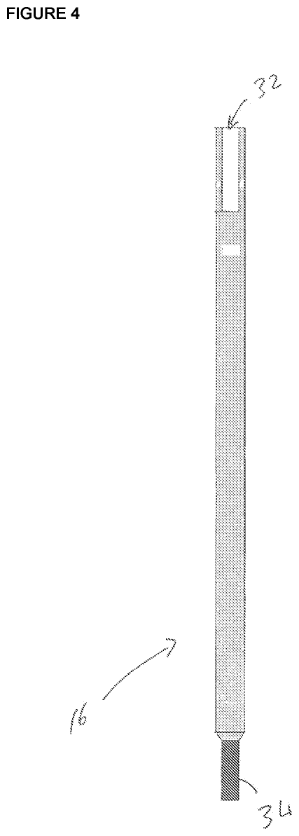

More clearly shown in FIG. 4, shaft 16 includes a drive member interconnecting formation 32 defined about an upper end region thereof for releasable interconnecting with the drive member 30. The shaft 16 also includes a paddle member interconnecting formation 34 defined about a lower end region thereof for releasable interconnecting with the paddle member 18 and 118.

Although the paddle member 18, 118 and shaft 16 is depicted herein as separate parts, the shaft 16 can also include the paddle member 18, 118 defined at a lower end region thereof.

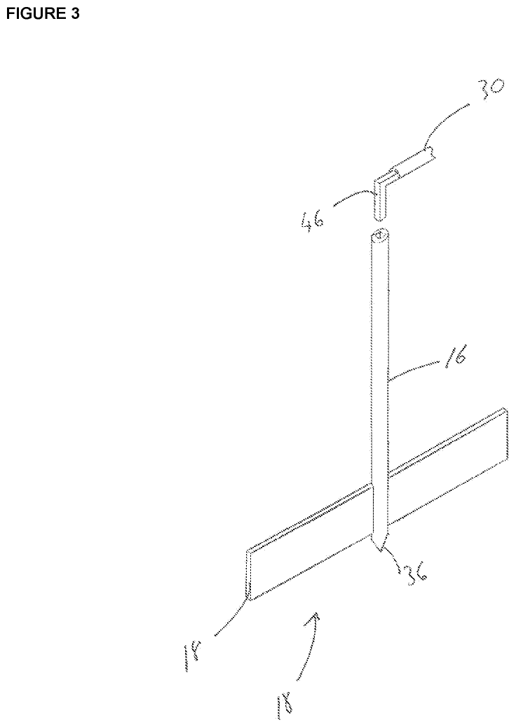

The paddle member 18, see FIG. 3, further includes a guide receiving formation 36 for rotatably receiving the first guide member 20.

In one embodiment, FIG. 3, the paddle member 18 includes a blade 38 arranged transversally the shaft 16.

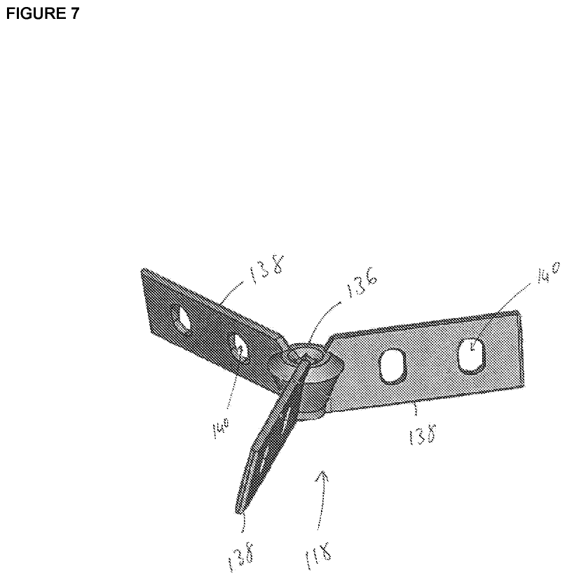

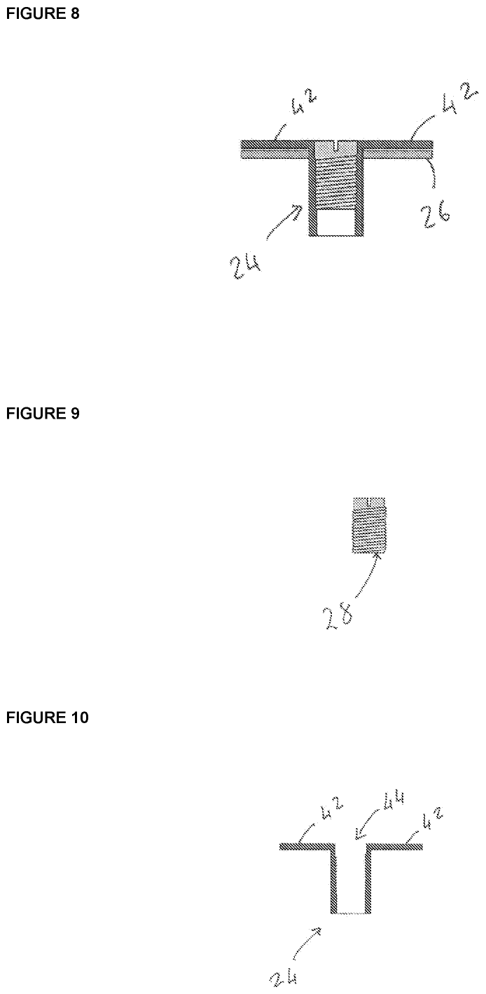

In another embodiment, FIG. 7, the paddle member 118 includes three evenly spaced apart blades 138 radiating from a central guide receiving formation 136.

The guide receiving formation 136 in this embodiment can be frustoconically shaped, with a tapered end region thereof adapted to accommodate the first guide member 20.

Each of the three blades 138 further includes apertures 140 defined therethrough so as to define a perforated paddle member 118.

The first guide member 20 can includes a guide protrusion (not shown) protruding from the receptacle floor 22 and arranged centrally therein for accommodating guide receiving formation 136.

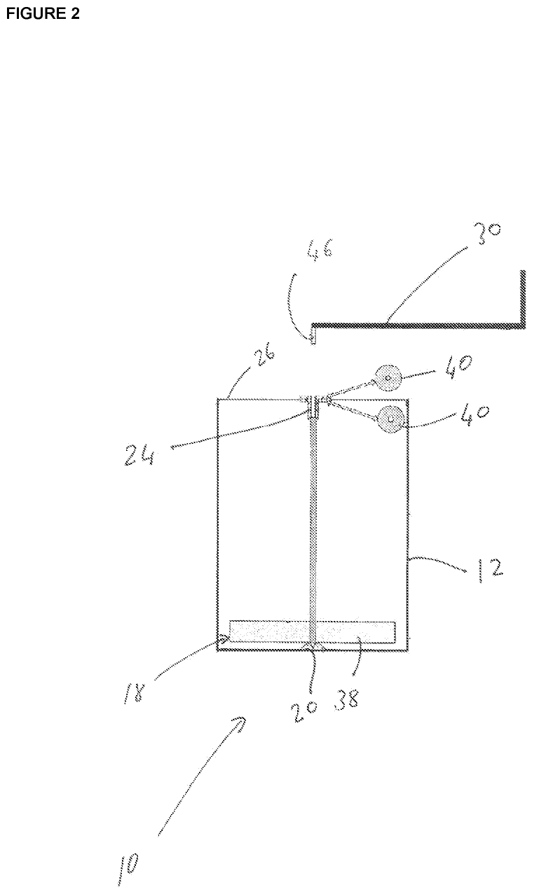

The first guide member can also be in the form of a female type formation, see FIG. 2, for accommodating the shaft 16 extending beyond paddle member 18, depicted in FIG. 3.

FIGS. 8 and 10 more clearly illustrates the second guide member 24 shaped and sized to fit in a friction fit manner in a centrally defined aperture of the receptacle lid 26.

Second guide member 24 includes sealing formations for sealably mounting the second guide member 24 into the centrally defined aperture of the receptacle lid.

The sealing formations can take the form of a pair of washers 40 mounted on either side of the lid, depicted in FIG. 2, or alternatively can be in the form of a flange 42 extending circumferentially about an upper end region of the second guide member, shown in FIGS. 8 and 10.

It is to be appreciated that the receptacle lid 26 can also include the second guide member 24, where the second guide member 24 extends downward the lid (not shown).

The second guide member 24 further include a centrally defined guide bore 44, shown in FIG. 10, for receiving an upper end region of the shaft 16.

FIGS. 8 and 10 show the inner surfaces of the guide bore 44 being threaded for receiving a complementary threaded surface defined about the sealing member 28 so as to allow screwing of the sealing member 28 into the second guide member 24.

The guide bore 44 can have an inner diameter of about 10 mm.

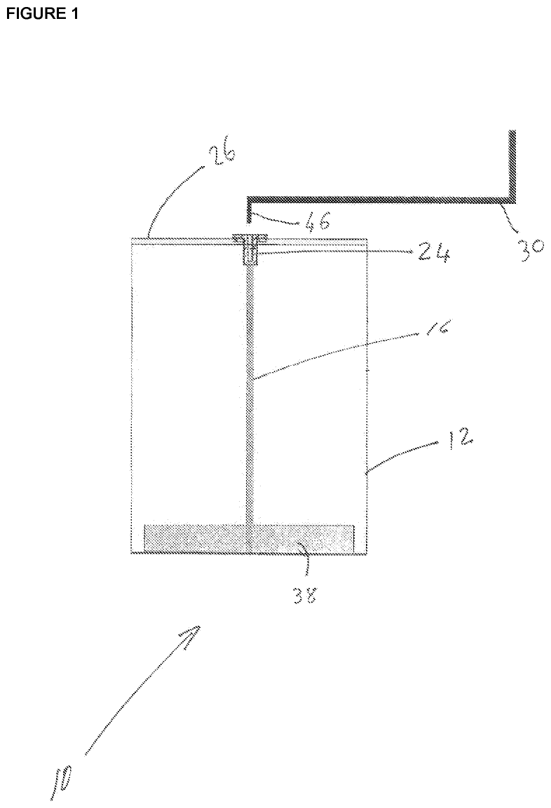

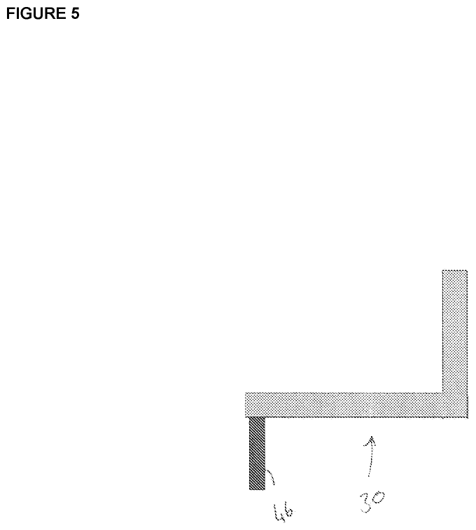

FIGS. 1, 2 and 5 shows the drive member 30 being substantially L-shaped in side view and including a shaft connecting portion 46 extending orthogonally away therefrom for releasable interconnection with an upper region of the shaft 16.

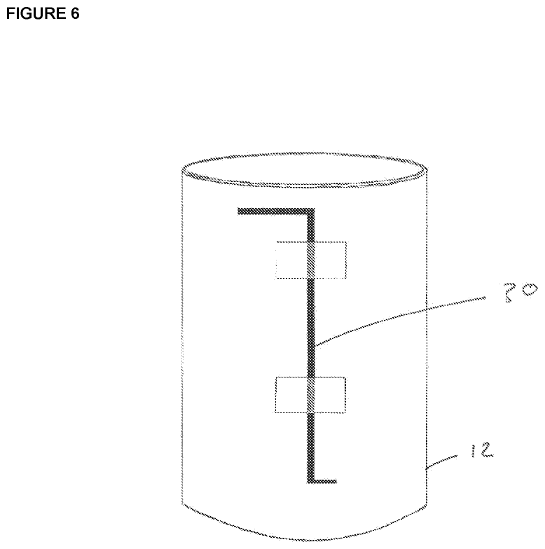

In use, see FIG. 6, the drive member 30 will be located on the side of the receptacle 12 and when needed, a user will remove the sealing member 28 and connected the shaft 16 for rotating the shaft 16 and thereby the paddle member 18 for stirring the liquid contained by the receptacle 12 without having to remove the receptacle lid 26.

The Applicant considers the invention advantageous in that a stirrer assembly is disclosed which can be utilised in the paint, or any other industry, where the mixing of the liquid is necessary before application or use thereof. The second guide member can further be utilised to dispense the liquid from the receptacle thereby minimise the risk of spills.

1. A stirrer assembly for, in use, stirring liquid in a receptacle, which includes:
a receptacle receiving portion which is locatable inside the receptacle;
the receptacle receiving portion further including:
a shaft; and
a paddle member extending from a bottom region of the shaft;
a first guide member which is mountable onto a floor of the receptacle for rotatably guiding the paddle member;
a second guide member which is defined centrally a receptacle lid and extending downward therefrom, for in use, rotatably guiding an upper region of the shaft;
a sealing member for releasably sealing the second guide member; and
a drive member which is connectable to the upper region of the shaft, for in use, transmitting torque to the shaft upon rotation of the said drive member;
wherein the receptacle receiving portion is dimensioned so that the upper end region of the shaft does not protrude beyond an upper surface of the second guide member.

2. A stirrer assembly as claimed in claim 1 wherein the shaft includes a drive member interconnecting formation defined about an upper end region thereof for releasable interconnection with the drive member.

3. A stirrer assembly as claimed in claim 1, wherein the shaft includes a paddle member interconnecting formation defined about a lower end region thereof for releasable interconnecting with the paddle member.

4. A stirrer assembly as claimed in claim 1 wherein the shaft includes the paddle member.

5. A stirrer assembly as claimed in claim 1, wherein the paddle member includes a guide receiving formation for rotatably receiving the first guide member.

6. A stirrer assembly as claimed in claim 1, wherein the paddle member includes a blade arranged transversally the shaft.

7. A stirrer assembly as claimed in claim 5, wherein the paddle member includes three evenly spaced apart blades radiating from the guide receiving formation.

8. A stirrer assembly as claimed in claim 5, wherein the guide receiving formation is frustoconically shaped, with a tapered end region thereof adapted to accommodate the first guide member.

9. A stirrer assembly as claimed in claim 7, wherein each of the three blades further includes apertures defined therethrough so as to define a perforated paddle member.

10. A stirrer assembly as claimed in claim 1, wherein the first guide member includes a guide protrusion protruding centrally away from the receptacle floor.

11. A stirrer assembly as claimed in claim 1, wherein the second guide member is shaped and sized to fit in a friction fit manner in a centrally defined aperture of the receptacle lid.

12. A stirrer assembly as claimed in claim 1, wherein the second guide member includes sealing formations for sealably mounting the second guide member into a centrally defined aperture of the lid.

13. A stirrer assembly as claimed in claim 12, wherein the sealing formations take the form of a pair of washers mounted on either side of the receptacle lid.

14. A stirrer assembly as claimed in claim 12, wherein the sealing formations take the form of a flange extending circumferentially about an upper end region of the second guide member.

15. A stirrer assembly as claimed in claim 1, wherein the receptacle lid includes the second guide member.

16. A stirrer assembly as claimed in claim 1, wherein the second guide member includes a centrally defined guide bore for receiving an upper end region of the shaft.

17. A stirrer assembly as claimed in claim 16, wherein the inner surfaces of the guide bore are threaded for receiving a complementary threaded surface defined about the sealing member so as to allow screwing of the sealing member into the second guide member.

18. A stirrer assembly as claimed in claim 1, wherein the drive member is substantially L-shaped in side view and including a shaft connecting portion extending orthogonally away therefrom for releasable interconnection with an upper region of the shaft.

19. (canceled)

20. (canceled)

21. (canceled)
